(19) United States
(12) Patent Application Publication
(10) Pub. No.: US 2012/0203669 A1
(43) Pub. Date: Aug. 9, 2012

(54) Method for Determing a Dynamic Bundle Price for a Group of Sales Products and a Computer Program Product

(75) Inventors: Alexander Borsch, Chemnitz (DE); Jan Lippert, Leisnig (DE)

(73) Assignee: PRUDSYS AG, Chemnitz (DE)

(21) Appl. No.: 13/020,155

(22) Filed: Feb. 3, 2011

(51) Int. Cl. G06Q 30/00

(52) U.S. Cl. 705/27.1

(57) ABSTRACT

A method is provided for determining a dynamic bundle prices for a group of sales products. A computer program product and a computer system are further provided to determine the dynamic bundle price for the group of sales products by means of an application implemented on the computer system.

The disclosure relates to a method for determining a dynamic bundle price for a group of sales products and a computer program product.

### BACKGROUND AND SUMMARY OF THE DISCLOSURE

There are known methods in which sales prices for products are calculated dynamically in a computer system with the aid of electronic data processing. Such methods are used in online commerce, for example, to react flexibly to conditions for online commerce which change over time. If a customer is interested in a certain product, he can initiate an inquiry about the product and thus, in particular, an inquiry into its sales price, through his web browser. There are known methods which dynamically determine a current sales price for a single product in response to such an inquiry and transmit this dynamic product price to the customer so that the price is displayed on the customer's computer screen. With the aid of such a dynamic price determination, the sales price of a current sales situation can be defined variably in accordance. For example, sales figures achieved in the past can be taken into account in this way (cf., for example, LIPPERT, Whitepaper, DYNAMIC PRICING, available at http://www.prudsys.de/nc/produkte/prudsys-rde/rde-pricing/?tx_drblob_pil%5BdownloadUid%5D=203).

In conjunction with online commerce, it is also known that additional products may be displayed to a customer making inquiries through his web browser in addition to the sales product about which the customer has inquired. For example, a selection of such additional products is made on the basis of similarity criteria, which are evaluated for the product of the inquiry and the additionally selected products (cf., for example, GELIN ET AL., NÄHER AM KUNDEN [CLOSER TO THE CUSTOMER], April 2010 Edition, WebSelling, 2010).

The embodiments of the present disclosure provide a method for determining a dynamic bundle price for a group of sales products available through online commerce.

An illustrative method for determining a dynamic bundle price for a group of sales products is provided. The present disclosure relates to a computer program product, according to independent claim 8. Embodiments of the present disclosure are the subject matter of the dependent subsidiary claims.

According to one aspect of the present disclosure, a method for determining a dynamic bundle price for a group of sales products by means of an application implemented on a computer system is provided, the method comprising the following steps:

providing electronic information pertaining to a selection of a sales product,

determining the group of sales products by selecting at least one additional product—from a plurality of additional products and assigning it to the sales product of the selection, such that the group of sales products comprises at least one product to which a variable sales price is assigned,

determining a price-sales function of the group of sales products,

determining a price elasticity for the group of sales products,

determining the dynamic bundle price for the group of sales products from the price-sales function and the price elasticity, and

providing electronic output information, which displays product information-pertaining to the group of sales products and product information pertaining to the dynamic bundle price.

A method for dynamic product optimization and price optimization by means of a computer system using an electronic database comprises the steps of:

providing electronic information on a first product;

determining whether the first product is capable of being bundled with a second product;

determining that the first product and the second product are capable of being bundled to form a product bundle;

selecting the second product by a similarity determination;

calculating a price-sales function based on a linear relationship between price and sales for the product bundle;

determining a price elasticity for the product bundle;

optimizing a dynamic bundle price for the product bundle based on the price-sales function and the price elasticity; and

outputting the dynamic bundle price for the product bundle.

According to another aspect of the disclosure, a computer program product for determining a dynamic bundle price for a group of sales products by means of an application running on a computer system is provided, the computer product comprising:

means for providing electronic information pertaining to a selection of a sales product,

means for determining the group of sales products by selecting at least one additional product from a plurality of additional products and assigning it to the sales product, such that the group of sales products comprises at least one product to which a variable sales price is assigned,

means for determining a price-sales function for the group of sales products,

means for determining a price elasticity for the group of sales products,

means for determining the dynamic bundle price for the group of sales products from the price-sales function and the price elasticity, and

means for providing electronic output information, which displays product information pertaining to the group of sales products and displays price information pertaining to the dynamic bundle price.

An alternative method of the present disclosure may include the step of offering groups of sales products or articles, which can also be referred to as bundles, with a dynamic price structure. This method may be implemented in a client-server computer system, where it is possible to provide for a plurality of client computers to be permanently or temporarily connected via data technology to a central server system, in which the dynamic bundle price determination is performed in response to a client inquiry. The dynamically determined bundle price, i.e., the sales price for a selected group of sales products or articles, is then transmitted to the client computer, for example, for intermediate storage or for direct display on a display screen of the client computer.

The group of sales products may also be referred to as a plurality of sales products.

In one embodiment, it is possible to provide for the dynamic bundle price to be determined in response to a product inquiry by a user. Alternatively, it is possible to provide for the dynamic bundle price determination to be performed proactively before a user inquiry in order to supply the bundle price in the event of a user inquiry and then transmit it to the user.

Within the scope of determining the dynamic bundle price, the price-sales function is determined for the previously determined group of sales products. In addition, the price elasticity for the group of sales products is also determined. Starting from these two items of information, the dynamic bundle price is then determined by determining an optimum discount, which is derived from the price elasticity. The group or plurality of sales products is treated here as a (single) product for which the dynamic price is determined.

Alternatively, the method step of determining the group of sales products may further comprise selecting the at least one additional product within the scope of a similarity choice. The similarity choice may be made, for example, as part of so-called duplicate recognition, which is known in various embodiments and, therefore, will not be discussed further here.

In an embodiment of the present disclosure, it is possible for the step of determining the group of sales products to further include selecting the at least one additional product as part of a reinforcement learning choice. Reinforcement learning belongs to the processes of so-called machine learning. The group of sales products is determined here with the aid of self-learning algorithms, which may be performed in realtime. The selection method learns automatically, by way of so-called reward and punishment processes.

According to an alternative embodiment of the present disclosure, the step for determining the price elasticity further comprises determining a profit function for the group of sales products from the price-sales function, and the step for determining the dynamic bundle price further comprises determining the dynamic bundle price for the group of sales products from the profit function and the price elasticity. The profit function takes into account profit-reducing costs such as shipping costs, packaging costs and/or fees, which accrue, for example, due to single orders. Since the group of sales products is handled as a single product in the dynamic price determination, these costs are also handled jointly.

According to a further embodiment of the present disclosure invention, after the step for providing the electronic information pertaining to the choice of the product, at least one of the subsequent method steps is preferably performed as a real-time application.

In a further embodiment of the present disclosure, it is possible for the step for providing the electronic output information to further comprise storing the electronic output information in a memory unit and transmitting the electronic output information in response to a user request. In this way, in one embodiment, the determination of the dynamic bundle price may first be performed proactively without already having a user inquiry. The temporarily stored bundle price is then transmitted to the client computer of the user when an inquiry about a sales product is received from that computer.

According to a further embodiment of the present disclosure, the dynamic bundle price for the group of sales products is updated at least once using at least one of the price-sales function and the price elasticity. In one embodiment, repeated updating of the dynamic bundle price for the group of sales products may be performed at fixed intervals of time, for example, every 24 hours or every week. The updated bundle price may then be stored in a memory unit of a computer system, so that a current dynamic bundle price, based on a current price-sales function and a current price elasticity, is always available for a user inquiry. Updating may be repeated at fixed or variable intervals of time.

### BRIEF DESCRIPTION OF THE DRAWINGS

The embodiments of the present disclosure are explained in greater detail below with reference to the figures in the drawings, which show:

FIG. 1 is a schematic diagram of a computer system to illustrate a method for dynamically determining product information as well as calculating a dynamic price in conjunction with online shopping,

FIG. 2 is a flowchart for one embodiment of the method of dynamic product and price bundling,

FIG. 3 is a schematic diagram to illustrate a self-learning algorithm for use with the computer system and the method,

FIG. 4 is a schematic diagram for a linear price-sales function, and

FIG. 5 is a schematic diagram of a bundle grouping according to price elasticity.

### DETAILED DESCRIPTION OF THE DRAWINGS

A method for dynamic product optimization and price optimization by means of a computer system using an electronic database is described below on the basis of the exemplary embodiments.

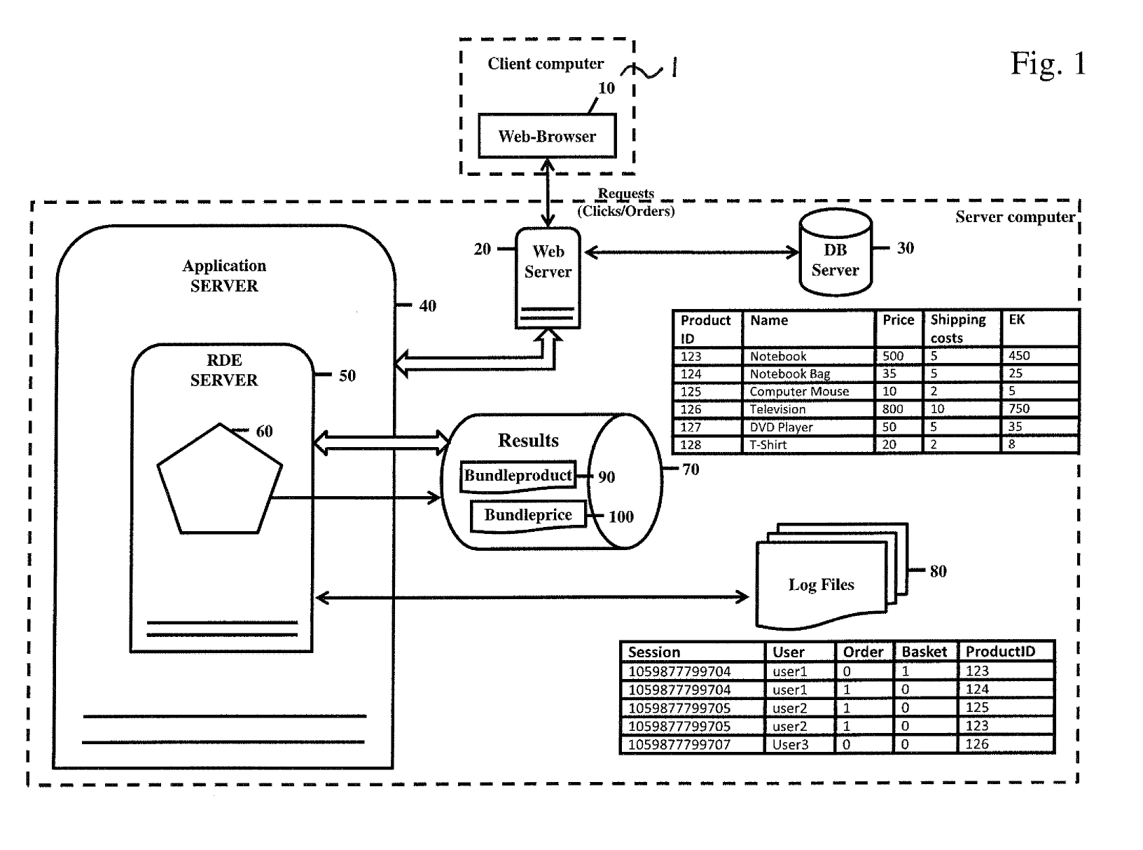

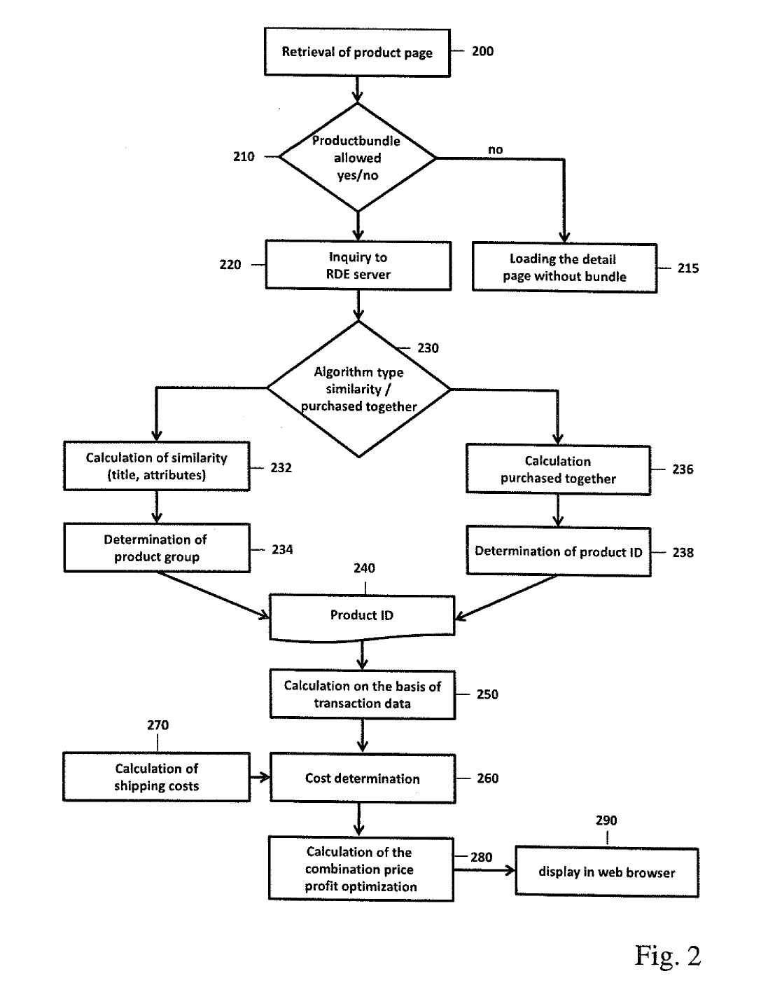

FIGS. 1 and 2 show a schematic diagram and a flowchart of a computer system to illustrate a method for dynamically determining product information and calculating a dynamic process in conjunction with an online shop. A client computer 1 accesses a web server 20 via a web browser 10. A website is retrieved here (cf., step 200 in FIG. 2) to provide information about a product of an inquiry or selection. Then the web server 20 checks whether the product retrieved allows so-called product bundling, i.e., the combined offering together with at least one other product as a product group or a product bundle (step 210). This information is contained in an electronic database 30.

If product bundling is not allowed, a detail page is retrieved (step 215) without a product bundle. If product bundling is allowed for the product retrieved, the web server 20 sends an inquiry to an RDE server 50 (RDE—Realtime Decisioning Engine) (step 220), which is embedded in an application server 40. The RDE server 50 then decides whether a similarity recommendation or a classical product recommendation is to be used (step 230) in the choice of the at least one additional product to be assigned to the product retrieved. A classical product recommendation or a product recommendation in the sense used here is a recommendation based on clicks, shopping carts and/or purchases. The similarity determination is then performed in step 232, according to FIG. 2.

The product recommendation is determined in step 236. This step may comprise one or more sub-steps, such as determination of clicks by users, shopping carts and/or actual sales pertaining to the products.

Determining the at least one additional product for the group of sales products (bundled products) is based on similarities, such as duplicate recognition. Master data from the database 30, for example, product title, product group or the like are compared here, resulting in a numerical similarity:

$$a , b , ∈ ℝ$$

$$similarity = 1 - \frac{\vert a - b \vert}{max ( \vert a \vert , \vert b \vert )}$$

where (a) corresponds to data or parameters for the sales product and (b) corresponds to data or parameters for the additional product comprising the group of sales products.

To perform a ranking, the individual fields are evaluated (i.e., a fieldweight) to arrive at a total score for the product similarity:

$$score = ruleweigt * {\sum }_{i}^{\vert fields \vert} \frac{{similarity}_{i} * {fieldweight}_{i}}{\vert fields \vert}$$

Individual fields are understood here to refer to comparative product attributes, for example, title, category membership, manufacturer, colors and the like.

The product having the highest score is the most numerically similar to the product retrieved and is proposed as a component of the bundle to be formed. The determination is performed by means of an application 60. The result is the determination of a group of sales products (bundle) which are to be offered jointly (step 234). The result is stored as a bundled product 90 in a server memory 70.

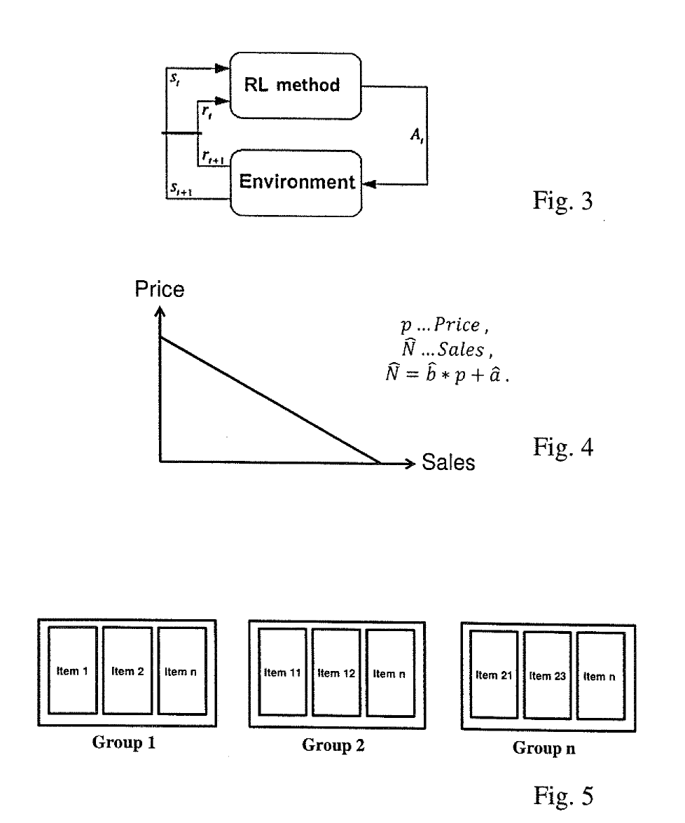

Product bundles may also be generated in realtime by self-learning algorithms. The basis for this is, for example, reinforcement learning (RL). RL is a process of machine learning. The system learns through rewards and penalties. FIG. 3 shows a schematic diagram to illustrate this in conjunction with reinforcement learning.

The method learns a utility function, for example, that of sales maximization, on the basis of positive rewards and negative rewards (penalties). The environment here may assume various states Sᵢ. This state is the current bundle recommendation (the recommended product). A reward rᵢ is generated, depending on acceptance of the product (e.g., increased sales). The agent has this information and decides the next action Aᵢ, from which a new state (new product/bundle recommendation) follows. This chain is repeated over and over. The learning algorithm is also known as an agent in the field of artificial intelligence. In the course of the iterations, the agent learns and attempts to maximize the rewards it receives. All future rewards are also taken into account here. In the context of the product bundle, the system is continuously learning the best recommendation for the utility function. This yields the utility of a state sequence \vec{S}, where the state sequence contains all states selected for S in the optimal case.

$$\begin{matrix}U ( s ) = {\sum }_{i = 0}^{∝} {γ}^{i} R ( {s}_{i} ) \\ 0 \leq γ \leq 1 \\ = R ( {s}_{0} ) + γ \cdot {\sum }_{i = 0}^{∝} {γ}^{i} R ( {s}_{i} + 1 ) \\ = R ( {s}_{0} ) + γ \cdot U ( {s}_{1} )\end{matrix}$$

A reduction factor γ may be used, so that the sum of the utility function will remain finite and will not grow to an unlimited extent. For the correct utility function, this yields the Bellman equation,

$$U ( s ) = R ( s ) + γ \cdot {max}_{A} {\sum }_{{s}^{′}} T ( s , A , {s}^{′} ) U ( {s}^{′} )$$

which in turn yields the so-called Bellman update:

$${U}_{i + 1} ( s ) = R ( s ) + γ \cdot {max}_{A} {\sum }_{{s}^{′}} T ( s , A , {s}^{′} ) {U}_{i} ( {s}^{′} )$$

The function T(s, A, s′) here represents the probability that the environment will assume the state s′ if the action A is performed in the state s.

The equation yields an updating rule for learning with a temporal difference:

Uᵢ₊₁(s)=Uᵢ(s)α[R(s)+γ·Uᵢ(s′)−Uᵢ(s)]

The parameter x here is the learning parameter and is between zero and one.

The function value of the utility function U is updated at the site s by means of the difference between the expected function value R(s)+γ*Uᵢ(s′)) and the actual function value (y(s)) at the site s.

With each click, purchase or shopping cart action, the utility function can be updated for the product bundles. In this form, each possible state and thus, each product recommendation can be implemented to learn the correct utility function. Alternatively, the function may be approximated, rather than learned in tabular form. For example, the function may be approximated by representing U as shown below:

$${\hat{U}}_{θ} ( s ) = {\sum }_{i = 0}^{n} {θ}_{i} {ϕ}_{i} ( s )$$

With this linear combination of the ansatz functions φᵢ only one update of θᵢ is necessary. This is done as follows:

θᵢ=θᵢ+α[R(s)+γ·\tilde{U}_{θ}(s′)−U_{θ}(s)]·φᵢ(s)

If the utility function has been learned, it is possible to decide whether or not the product will serve again as a bundle. Now, the product recommendation at which the utility function U is at its maximum is selected. This strategy is known as the “greedy policy.” As long as the utility function is not learned optimally, this strategy may fail. It is therefore necessary to conduct an investigation, i.e., ε% of all steps are presumably performed best for precisely the opposite action. This strategy is known as the “ε-Greedy Policy.”

The calculation is likewise performed on the RDE server 50 with the application 60. The responses to the recommendations are determined as log files 80 (cf., FIG. 1). A determination is performed (step 238). This result is stored in the server memory 70 as bundled product 90.

The information about the certain product bundle comprises so-called product identifications (IDs) for the products assigned to one another in the group. The product IDs are available as an output document (step 240). Then, the price-sales function for the group of sales products is determined using the application 60. The price-sales function (step 250) is calculated on a product group basis. A linear functional relationship between price and sales may be assumed (cf., FIG. 4).

FIG. 5 shows a schematic diagram of a product bundle grouping according to the price elasticity. Possible product bundles are subdivided here into multiple elasticity groups 1 . . . n having the same price elasticity. In the simplest case, they may also be differentiated here according to low, medium or high elasticity or also according to actual values. The elasticity classification is selected by the user. In this way, product bundles of similar price elasticity, i.e., which are assigned to the same elasticity group, are compared according to their change in discount. It is thus possible to control discounting practice appropriately even with a few sales.

In step 250, according to FIG. 2, all transaction data on the product bundle are analyzed for the further processing, for example, clicks, purchases and/or shopping carts.

In step 260, according to FIG. 2, the discount-sales function is calculated for the bundled product and is formed with the aid of the reference price p₀ (MRP).

$$\begin{matrix}N ( r ) = \hat{N} ( p ) \\ = \hat{b} \cdot ( {p}_{0} \cdot ( 1 - r ) ) + \hat{a} \\ = - \hat{b} {p}_{0} \cdot r + \hat{b} {p}_{0} + \hat{a} \\ = b \cdot r + a ,\end{matrix}$$

$$b = - \hat{b} {p}_{0}$$

$$a = \hat{b} {p}_{0} + \hat{a}$$

The price elasticity is determined in step 270 using the following equation:

$${ɛ}_{{\hat{N}}_{{p}_{0}}} = - \frac{b}{a} = - c$$

The negative price elasticity within a group is identified as −c. The profit function for the bundle of products is derived as follows from the discount-sales function, where (k) includes the piece costs and G is represented as profit=sales·(price−cost):

$$\begin{matrix}G ( r ) = N ( r ) \cdot ( p - k ) \\ = ( b \cdot r + a ) \cdot ( {p}_{0 } \cdot ( 1 - r ) - k ) \\ = - b {p}_{0} \cdot {r}^{2} + ( b {p}_{0} - bk - a {p}_{0} ) \cdot r + a {p}_{0} - ak .\end{matrix}$$

The optimum discount is determined using the first derivation of the profit function, optionally taking product-relevant costs into account (steps 260, 270):

$${G}^{′} ( r ) = - 2 {bp}_{0} r + {bp}_{0} - bk - {ap}_{0} {=}^{!} 0.$$

$${r}_{opt} = \frac{1}{2} ( 1 - \frac{k}{{p}_{0}} - \frac{a}{b} ) = \frac{1}{2} ( 1 - Δ - c ) where Δ = \frac{k}{{p}_{0}}$$

The equation requires determination of the price elasticity per group:

n . . . number of products in the group

m . . . number of test strips

Nᵢ^{t} . . . sales of product i in time increment t,

rᵢ^{t} . . . discount on product i in time increment t,

{rᵢ^{t},Nᵢ^{t}} . . . ∀i=1, . . . ,nΛt=1, . . . ,m.

Sales for the bundled product are considered per unit of time (day, week, etc.).

$${N}^{t} = {\sum }_{i = 1}^{n} {N}_{i}^{t} = {\sum }_{i = 1}^{n} {b}_{i} \cdot {r}_{i}^{t} + {\sum }_{i = 1}^{n} {a}_{i}$$

$${\tilde{r}}^{t} = {r}_{i}^{t} + \frac{1}{2} {Δ}_{i} .$$

For all i=1, . . . , n, all \tilde{r}^{t} are constant. In the next step, \tilde{r}^{t} is inserted into N^{t}.

$${N}^{t} ( {\tilde{r}}^{t} ) = {\sum }_{i = 1}^{n} {b}_{i} \cdot ( {\tilde{r}}^{t} - \frac{1}{2} {Δ}_{i} ) + {\sum }_{i = 1}^{n} {a}_{i} = {\sum }_{i = 1}^{n} {b}_{i} \cdot {\tilde{r}}^{t} - {\sum }_{i = 1}^{n} {b}_{i} \cdot \frac{1}{2} {Δ}_{i} + {\sum }_{i = 1}^{n} {a}_{i} = {\tilde{r}}^{t} \cdot B - {\sum }_{i = 1}^{n} {b}_{i} \cdot \frac{1}{2} {Δ}_{i} + A = {\tilde{r}}^{t} \cdot B + \tilde{A} ,$$

where

$$B = {\sum }_{i = 1}^{n} {b}_{i} , \\ A = {\sum }_{i = 1}^{n} {a}_{i} = {\sum }_{i = 1}^{n} c \cdot {b}_{i} = c \cdot {\sum }_{i = 1}^{n} {b}_{i} = c \cdot B , \\ \tilde{A} = A - {\sum }_{i = 1}^{n} {b}_{i} \frac{1}{2} {Δ}_{i} , \\ c = \frac{A}{B} .$$

The parameters Ã and B are determined using the method of least squares:

$$B = \frac{m {\sum }_{t = 1}^{m} {\tilde{r}}^{t} {N}^{t} - {\sum }_{t = 1}^{m} {\tilde{r}}^{t} {\sum }_{t = 1}^{m} {N}^{t}}{m {\sum }_{t = 1}^{m} {( {\tilde{r}}^{t} )}^{2} - {( {\sum }_{t = 1}^{m} {\tilde{r}}^{t} )}^{2}} . \\ \tilde{A} = \frac{1}{m} ( {\sum }_{t = 1}^{m} {N}^{t} - B \cdot {\sum }_{t = 1}^{m} {\tilde{r}}^{t} ) .$$

Ã is estimated using the estimate for the value Σᵢ₌₁ⁿbᵢ·½Δᵢ. It is thus also possible to determine c. This yields the following first approximation:

$${\sum }_{i = 1}^{n} {b}_{i} \cdot \frac{1}{2} {Δ}_{i} \approx \frac{1}{n} {\sum }_{i = 1}^{n} {b}_{i} \cdot {\sum }_{i = 1}^{n} \frac{1}{2} {Δ}_{i}$$

However, this approximation is good only if bᵢ or Δᵢ does not have too much scattering. Since no information about bᵢ is available, the investigation is limited to Δᵢ. Since the individual Δᵢ are known, it is possible to classify the products of a group in such a way that the range of Δᵢ is less than bᵢ in each subgroup:

k . . . number of subgroups (=amount of all products of a group)

$${{⋂}_{j - 1}}^{k} {M}_{j} = φ ⋀ {{⋃}_{j - 1}}^{k} {M}_{j} = M ,$$

nⱼ number of products in subgroup Mⱼ

$${\overline{Δ}}_{j} = \frac{1}{{n}_{j}} {\sum }_{i ∈ {M}_{i}} {Δ}_{i} , \\ {max}_{i ∈ {M}_{j}} \vert {\overline{Δ}}_{j} - {Δ}_{i} \vert \leq d ∀ j = 1 , … , k , \\ {\sum }_{i = 1}^{n} {b}_{i} \cdot \frac{1}{2} {Δ}_{i} = {\sum }_{j = 1}^{k} {\sum }_{i ∈ {M}_{j}} {b}_{i} \cdot \frac{1}{2} {Δ}_{i} \approx {\sum }_{j = 1}^{k} \frac{1}{{n}_{j}} {\sum }_{i ∈ {M}_{j}} {b}_{i} \cdot {\sum }_{i ∈ {M}_{j}} \frac{1}{2} {Δ}_{i} = \frac{1}{2} {\sum }_{j = 1}^{k} {B}_{j} \cdot {\overline{Δ}}_{j} .$$

The quantities Mⱼ are disjunctive. The parameters Bⱼ/=Σ_{iεM}_{ⱼ} bᵢ are also calculated by the method of least squares for each subgroup. This yields the following estimate for A:

$$A \approx \tilde{A} + \frac{1}{2} {\sum }_{j = 1}^{k} {B}_{j} \cdot {\overline{Δ}}_{j} .$$

The elasticity constant c is determined by determining the parameters A and B, and thus the optimum discount for each product is determined. The bundle of products previously determined is treated as an “independent” product as such, so that both costs and cost advantages are considered jointly.

The (discounted) bundle price 100 thereby determined for the group of sales products (step 280) is stored in the memory 70 (cf., FIG. 1) and can thus be displayed promptly in online shopping. It may change in realtime, i.e., be determined anew in realtime and thus updated. The products of the bundle thus determined and the bundle price are displayed in the web browser 10 of the client computer 1 (step 290), which obtains the information from the memory 70.

The features of the present embodiments disclosed in the preceding description, the claims and the drawings may be important, either individually or in any combination, for the implementation of the disclosure in its various in embodiments.

1. A method for determining a dynamic bundle price for a group of sales products by means of an application running on a computer system, wherein the method comprises the following steps:
using a web browser to provide electronic information pertaining to a selection of a sales product,
providing a web server to determine the group of sales products by selecting at least one additional product from a plurality of additional products and assigning it to the sales product, such that the group of sales products comprises at least one product to which a variable sales price is assigned,
having an application server of the computer system determine a price-sales function for the group of sales products,
using the computer system to determine a price elasticity for the group of sales products,
using the computer system to determine the dynamic bundle price for the group of sales products from the price-sales function and the price elasticity, and
providing electronic output information from the computer system, which displays product information pertaining to the group of sales products and displays price information pertaining to the dynamic bundle price.

2. The method according to claim 1, wherein the step of providing the web server to determine the group of sales products further comprises selecting the at least one additional product as part of a similarity selection.

3. The method according to claim 1, wherein the step of providing the web server to determine the group of sales products further comprises selecting the at least one additional product as part of a reinforcement learning selection.

4. The method according to claim 1, wherein
the step of using the computer system to determine the price elasticity further comprises determining a profit function for the group of sales products from the price-sales function, and
the step of using the computer system to determine the dynamic bundle price further comprises determining the dynamic bundle price for the group of sales products from the profit function and the price elasticity.

5. The method according to claim 1, wherein at least one of the method steps is performed as a realtime application.

6. The method according to claim 1, wherein the step of providing the electronic output information further comprises storing the electronic output information in a memory device and transmitting the electronic output information in response to a user request.

7. The method according to claim 1, wherein the dynamic bundle price for the group of sales products is updated at least once using the price-sales function and the price elasticity.

8. A method for dynamic product and price optimization by means of a computer system using an electronic database comprises the steps of:
using a web browser to provide electronic information on a first product;
providing a web server to determine whether the first product is capable of being bundled with a second product;
using the web server to determine that the first product and the second product are capable of being bundled to form a product bundle;
selecting the second product through a similarity determination made by an application server of the computer system;
using the application server to calculate a price-sales function based on a linear relationship between price and sales for the product bundle;
having the computer system determine a price elasticity for the product bundle;
using the computer system to optimize a dynamic bundle price for the product bundle based on the price-sales function and the price elasticity; and
displaying on the computer system the output of the dynamic bundle price for the product bundle.

9. The method of claim 8, wherein the step of selecting the second product further includes comparing at least one product attribute of the second product to that of the first product, the product attribute selected from the group consisting of title, category, manufacturer, and color.

10. The method of claim 9, wherein the step of selecting the second product includes using a plurality of self-learning algorithms based on reinforcement learning.

11. The method of claim 10, wherein the plurality of self-learning algorithms determines a utility function based on approximation.

12. The method of claim 8, wherein the step of using the computer system to optimize the dynamic bundle price further includes storing the dynamic bundle price in a memory device of the computer system.

13. The method of claim 8, wherein the dynamic bundle price for the product bundle is updated at least once using at least one of the price-sales function and the price elasticity.

14. A computer program product for determining a dynamic bundle price for a group of sales products by means of an application running on a computer system, the computer product comprising:
means for providing electronic information pertaining to a selection of a sales product,
means for determining the group of sales products by selecting at least one additional product from a plurality of additional products and assigning it to the sales product, such that the group of sales products comprises at least one product to which a variable sales price is assigned,
means for determining a price-sales function for the group of sales products,
means for determining a price elasticity for the group of sales products,
means for determining the dynamic bundle price for the group of sales products from the price-sales function and the price elasticity, and
means for providing electronic output information, which displays product information pertaining to the group of sales products and displays price information pertaining to the dynamic bundle price.

15. The computer program according to claim 14, wherein the mean for determining the group of sales products further includes means for selecting the at least one additional product as part of a similarity selection.

16. The computer program according to claim 14, wherein the means for determining the group of sales products further includes means for selecting the at least one additional product as part of a reinforcement learning selection.

17. The computer program according to claim 14, wherein:
the means for determining the price elasticity further includes means for determining a profit function for the group of sales products from the price-sales function, and
the means for determining the dynamic bundle price further includes means for determining the dynamic bundle price for the group of sales products from the profit function and the price elasticity.

18. The computer program according to claim 14, wherein at least one of the means is a realtime application.

19. The computer program according to claim 14, wherein the means for providing the electronic output information further include means for storing the electronic output information in a memory device and means for transmitting the electronic output information in response to a user request.

20. The computer program according to claim 14, further comprising means for updating the dynamic bundle price for the group of sales products at least once using the price-sales function and the price elasticity.
